(19) United States
(12) Patent Application Publication
(10) Pub. No.: US 2011/0075571 A1
(43) Pub. Date: Mar. 31, 2011

(54) DISTRIBUTED VIRTUAL HOME AGENT FOR MOBILE INTERNET PROTOCOL

(76) Inventors: FANG HAO, Morganville, NJ (US); T.V. Lakshman, Morganville, NJ (US); Sarit Muherjee, Morganville, NJ (US)

(21) Appl. No.: 12/570,502

(22) Filed: Sep. 30, 2009

(51) Int. Cl. H04W 36/14; H04L 12/26

(52) U.S. Cl. 370/245; 370/331

(57) ABSTRACT

The present invention provides a method and apparatus for a distributed virtual home agent. One embodiment of the method includes implementing a first primary home agent on a first portion of a plurality of hardware elements that operate according to a mobile Internet Protocol (IP) and a second primary home agent on a second portion of the plurality of hardware elements. A first backup home agent is implemented on the second portion of the plurality of hardware elements and a second backup home agent is implemented on the first portion of the plurality of hardware elements. Packets addressed to the first or second primary home agent can be directed to both the first and second portions of the plurality of hardware elements so that states of the first and second backup home agents mirror states of the first and second primary home agents, respectively.

### BACKGROUND OF THE INVENTION

1. Field of the Invention

This invention relates generally to communication systems, and, more particularly, to wireless communication systems.

2. Description of the Related Art

Wireless communication systems use a geographically-dispersed network of interconnected base stations to provide wireless connectivity to mobile units. The network operates according to standards and/or protocols that allow roaming mobile units to hand off between the interconnected base stations so that call sessions are not interrupted when the mobile unit moves between geographic areas (or cells) served by different base stations. One example of a communication protocol that supports user mobility is Mobile Internet Protocol (IP). Mobile IP is an Internet Engineering Task Force (IETF) protocol that allows mobile units to move from one network to another while maintaining a permanent IP address. Mobile units that operate according to Mobile IP can be assigned two addresses: a permanent home address and a care-of address. A control plane entity called a home agent stores information about mobile units that have a permanent home address in the home agent's network. Foreign agents store information about mobile units that are visiting the foreign agent's network and advertise care-of addresses of these mobile units. The home agent receives packets addressed to the permanent home address and can redirect packets to the foreign agent using the care-of address when the mobile unit is roaming.

The base stations, backhaul networks, and other hardware deployed in the wireless communication system can be shared by multiple networks. For example, the wireless communication system may support a public network that is available to all registered users and may also support a private network that is only available to a particular subset of the registered users. The private network can maintain a database indicating the phone numbers, IP addresses, or other identifiers of the registered users that are allowed access to the private network. One example of a private network is a government network that is intended to be isolated from the public network and used only by government officials. Another possibility is that the private network may be used to support emergency services that may require high availability regardless of the traffic volume in the public or private networks. For example, the private network may provide medical workers with guaranteed access to patient records so that the medical workers can access this information immediately in emergency situations.

The public and private networks are typically separated to provide privacy, security, and/or reliability of the networks. However, current mobile IP networks lack support for privacy and security features. They also suffer from the flash crowd problem, in which the network may become overloaded and even melt down when lots of users simultaneously or concurrently turn on their devices or move across network boundaries. These problems need to be addressed in both the network data plane and the control plane. Issues in data plane can be addressed through resource reservation and encryption but currently there are no mobile IP solutions that support privacy, security, and reliability of public and private networks in the control plane. For example, conventional home agents do not support privacy, security, and overload control for public and/or private networks. Furthermore, the conventional home agent implementation employs an active/standby model that includes an active agent to handle the load and a standby agent that remains idle during normal operations. The standby agent maintains a copy of the current state of the active agent so that the standby agent can take over operations if the active agent should fail or become unavailable.

FIG. 1 conceptually illustrates one exemplary embodiment of a conventional home agent server 100 that includes two blades 105(1-2) that provide the CPU, memory, and other resources used by an active (primary) home agent and its corresponding standby (backup) agent. In the illustrated embodiment, the primary home agent is the home agent for both the group 1 and 2 networks, which can be public and/or private networks. The backup home agent acts as the backup home agent for both the group 1 and group 2 networks. A replicator 110 receives packets that are destined for the home agent, replicates the packets, and then sends a copy to both the primary home agent and the backup home agent. The primary home agent processes the packets and then forwards them towards the user and/or foreign agent, as appropriate. The backup home agent uses the replicated packets to maintain a state that is a mirror of the primary home agent state so that the backup home agent can take over operation if the primary home agent fails. The message load this configuration can handle is limited by the computational resources available on one blade 105(1) because the other blade 105(2) remains idle as long as the primary home agent on blade 105(1) is functioning normally. Thus, approximately half of the available resources remain unused during normal operation.

One alternative is to address the privacy and security issues by using physically separate networks for the public and private networks. For example, service providers can set up government networks that are physically separated from public networks and then implement independent home agents that run in parallel in the different networks. Although this approach can satisfy relatively high security and secrecy requirements, deploying and operating the hardware for two parallel and physically separate networks would be very expensive and generally not necessary for more modest security and secrecy requirements and/or for smaller networks. For example, the cost may be prohibitive to set up a physically different mobile IP network for each enterprise.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, an apparatus is provided for a distributed virtual home agent. One embodiment of the apparatus includes a plurality of hardware elements that provide processing and memory resources to support home agent functionality according to a mobile Internet Protocol (IP). A first primary home agent is implemented on a first portion of the hardware elements and a second primary home agent is implemented on a second portion of the hardware elements. A first backup home agent is implemented on the second portion of the plurality of hardware elements and a second backup home agent is implemented on the first portion of the hardware elements. A replicator is configured to provide packets addressed to either the first or second primary home agent to both the first and second portions of the hardware elements so that states of the first and second backup home agents mirror states of the first and second primary home agents, respectively.

In one embodiment, a method is provided for a distributed virtual home agent. One embodiment of the method includes implementing a first primary home agent on a first portion of a plurality of hardware elements that operate according to a mobile Internet Protocol (IP) and a second primary home agent on a second portion of the plurality of hardware elements. A first backup home agent is implemented on the second portion of the plurality of hardware elements and a second backup home agent is implemented on the first portion of the plurality of hardware elements. Packets addressed to the first or second primary home agent can be directed to both the first and second portions of the plurality of hardware elements so that states of the first and second backup home agents mirror states of the first and second primary home agents, respectively.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a conventional home agent server that includes two blades;

FIG. 2 conceptually illustrates one exemplary embodiment of a wireless communication system;

FIG. 3 conceptually illustrates one exemplary embodiment of a home agent server that includes multiple blades to support virtual home agents; and

FIG. 4 conceptually illustrates one exemplary embodiment of a method of implementing and operating virtual home agents.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

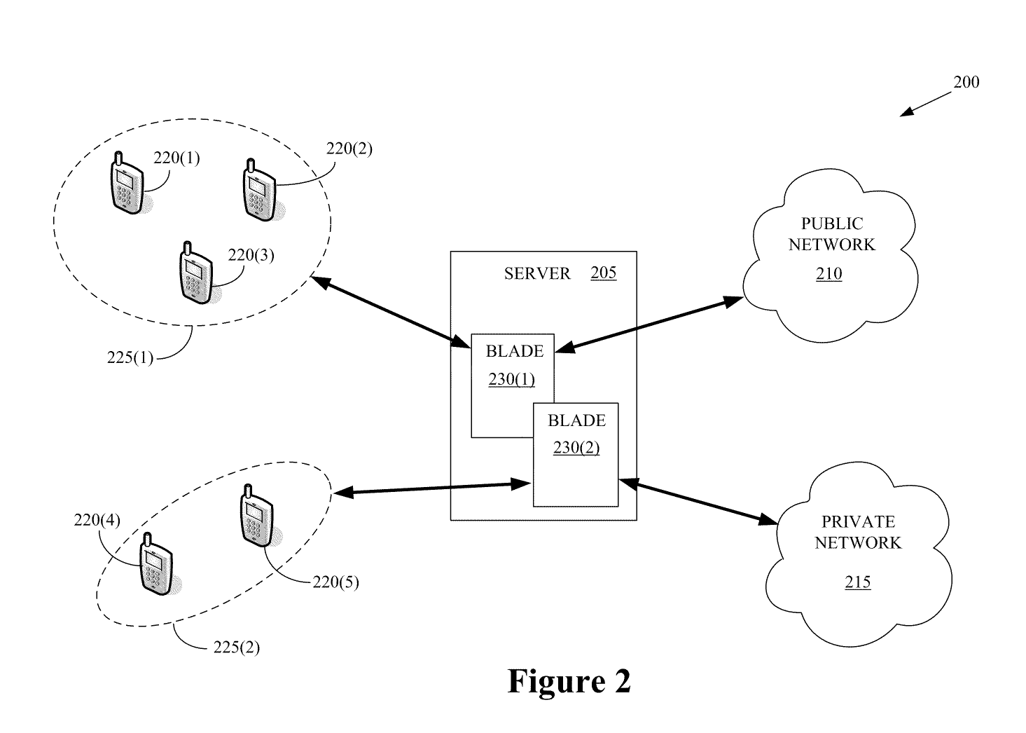

FIG. 2 conceptually illustrates one exemplary embodiment of a wireless communication system 200. In the illustrated embodiment, the wireless communication system 200 includes a server 205 that is configured to implement distributed virtual home agents that are used to provide access to a public network 210 and a private network 215. Examples of public networks 210 include the wireless communication networks provided by service providers such as Verizon, AT&T, and Sprint. Examples of private networks 215 include government networks that are reserved for use by government officials and emergency service networks that need high availability regardless of traffic volume to provide services to the police, the fire department, military, search-and-rescue teams, medical workers, and the like. The server 205 and the networks 210, 215 shown in FIG. 2 operate in accordance with the mobile Internet Protocol (IP). However, the techniques described herein are not limited to systems that operate according to mobile IP and in alternative embodiments elements of the wireless communication system 200 may operate according to any other standards and/or protocols. Moreover, persons of ordinary skill in the art having benefit of the present disclosure should appreciate that the embodiments depicted in FIG. 2 is intended to be illustrative and not to limit the number of servers 205 and/or networks 210, 215 that can be interconnected via the distributed virtual home agent described herein.

The wireless communication system 200 provides wireless connectivity to mobile units 220. The wireless connectivity may be provided using any combination of access points, base stations, base transceiver stations, base station routers, femtocells, and the like. In the interest of clarity, these elements are not depicted in FIG. 2 and persons of ordinary skill in the art should be able to implement, deploy, and/or operate these elements to provide wireless connectivity so that the mobile units 220 can communicate with the server 205 over one or more air interfaces, wireless connections, and/or wired connections. Wireless connectivity can be provided according to any standards and/or protocols including, but not limited to, CDMA, UMTS, 3GPP, and 3GPP2 standards and/or protocols.

The mobile units 220 are registered and/or authorized to use one or more of the networks 210, 215. In the illustrated embodiment, mobile units 220(1-3) are registered and/or authorized to use the public network 210 and so the mobile units 220(1-3) are assigned to the group 225(1). The mobile units 220(4-5) are registered and/or authorized to use the private network 215 and so the mobile units 220(4-5) are assigned to the group 225(2). Each mobile unit 220 can be registered and/or authorized to use one or more of the networks 210, 215 based on a prior negotiation with a service provider and/or dynamically using information exchanged with the wireless communication system 200 during a call session. The system 200 may keep track of the mobile units 220 that are registered and/or authorized to use the networks 210, 215 using, for example, a database that associates each mobile unit 220 with the appropriate networks 210, 215. The database may use various identifiers for the mobile units 220 such as a telephone number, an Internet address, a Mobile Identifier Number (MIN), an International Mobile Subscriber Identity (IMSI) number, and the like.

To offer isolation, protection, and improve service availability of mobile IP home agent, the server 205 uses virtualization technology to implement virtual home agents as a distributed system that runs on multiple Virtual Machines (VM). In the illustrated embodiment, the virtual home agents are distributed across multiple blades 230 that are implemented in the server 205. However, persons of ordinary skill in the art having benefit of the present disclosure should appreciate that the virtual home agents do not need to be implemented within the same “box” and can alternatively be implemented in physically separate devices such as servers deployed in different locations and interconnected to allow communication between the servers to coordinate operation of the virtual home agents.

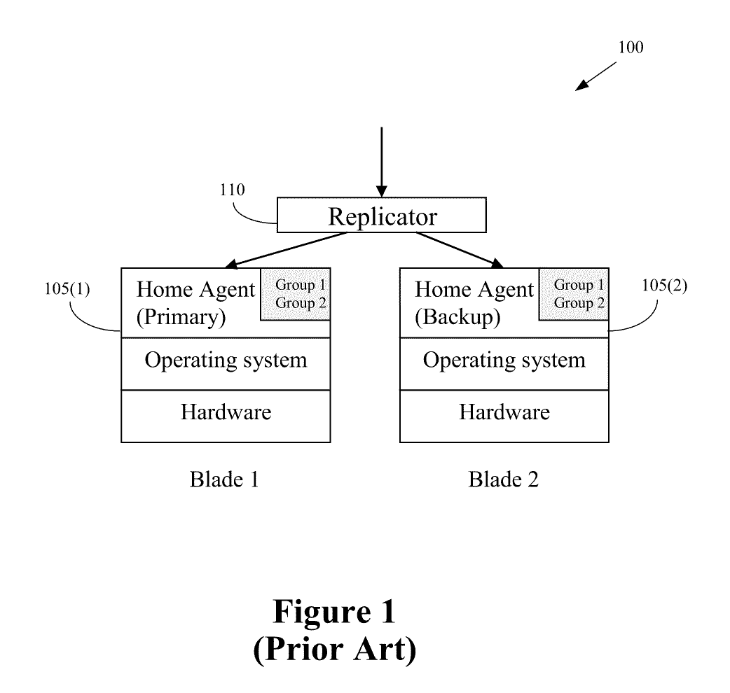

In the illustrated embodiment, the virtual home agents are distributed over the multiple blades 230 by implementing a primary home agent for the first group 225(1) on the blade 220(1). A backup home agent for the first group 225(1) is implemented on the blade 220(2). Similarly, the primary home agent for the second group 225(2) is implemented on the blade 220(2) and the backup home agent for the second group 225(2) is implemented on the blade 220(1). A replicator (not shown in FIG. 1) generates copies of the packets that are received by the server 205 and distributes copies of each of the packets to the different blades 230. The primary and backup home agents implemented on each of the blades 230 can use the copies of the packets to maintain mirror states of each other so that the backup home agent is prepared to support users in the event that the primary home agent fails or otherwise becomes unavailable.

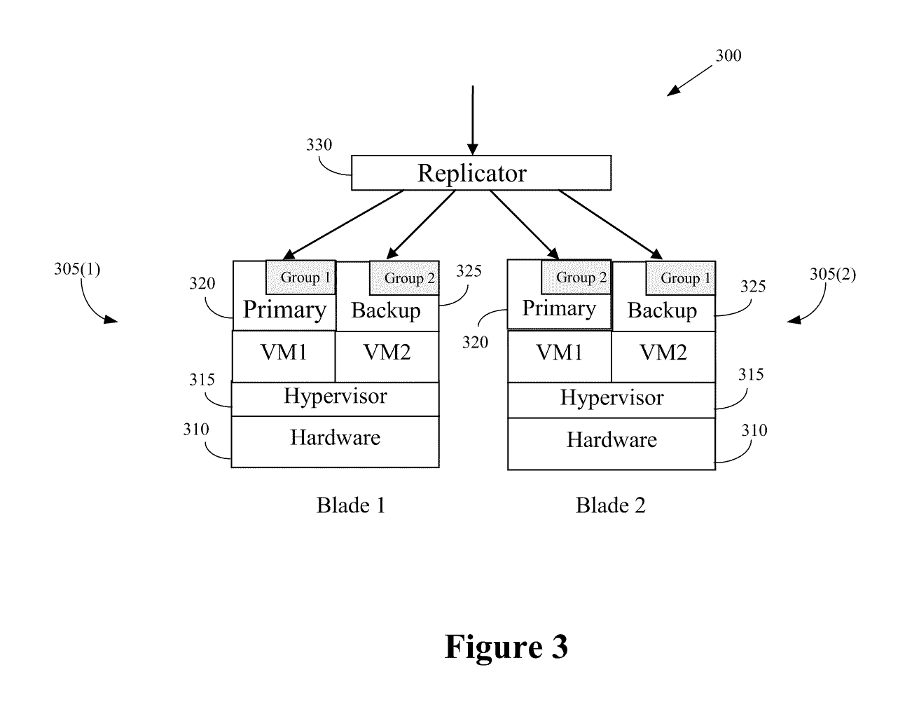

FIG. 3 conceptually illustrates one exemplary embodiment of a home agent server 300 that includes multiple blades 305 to support virtual machines. The number of virtual machines that run on each blade 305 can be adjusted according to the number of groups and/or networks that are supported in the wireless communication system. The number of groups and/or networks can be predetermined or may be negotiated dynamically during operation of the wireless communication system. In addition, the resources allocated to each group and the network can be predetermined or may be negotiated dynamically during operation of the wireless communication system.

Each blade 305 includes hardware 310 such as a processing element, a memory element, communication ports and connectors, and the like that are used to support the operation of the virtual home agents. A hypervisor 315 is also implemented in each blade 305. The term “hypervisor” will be used herein to refer to platform virtualization software that allows multiple operating systems to run concurrently on a host computer. A hypervisor may also be called a virtual machine monitor (VMM). In the illustrated embodiment, two virtual machines (VM1, VM2) are implemented in each blade 305. In the illustrated embodiment the virtual machine VM1 is used to implement a primary home agent 320 and the virtual machine VM2 is used to implement a backup home agent 325. The backup home agent 325 on blade 305(1) pairs up with a primary home agent on blade 305(2), and vice versa. Although FIG. 3 shows two blades 305 that are used to support two pairs of primary and backup home agents 320, 325 on two virtual machines (VM1, VM2), the techniques described herein may be straightforwardly extended by persons of ordinary skill in the art to include any number of blades, primary and backup home agents, and/or virtual machines.

The mobile user population has been divided into two groups: group 1 and group 2. For example, the users in group 1 may be registered with and/or authorized to use a first network and the users in group 2 may be registered with and/or authorized to use a second network. The users in the two groups are not necessarily mutually exclusive. For example, a user may be registered with and/or authorized to use both the first network and the second network, depending on the circumstances. The users in group 1 are therefore assigned to the primary home agent 320 on the blade 305(1) and the corresponding backup home agent 325 on the blade 305(2). The users in group 2 are assigned to the primary home agent 320 on the blade 305(2) and to the corresponding backup home agent 325 on the blade 305(1). Both primary home agents 320 are configured to handle requests for the corresponding group of users during normal operations and the backup home agents 325 are configured take over when the primary home agents 320 fail or otherwise become unavailable.

Packets associated with users in the groups are received by a replicator 330 in the server 300. The replicator 330 implements a packet distribution function and splits the traffic between different virtual machines (VM1, VM2) according to groups. In the illustrated embodiment, the replicator 330 makes copies of the received packets and distributes the copies to the virtual machines on the blades 305 so that the primary home agents 320 and backup home agents 325 can mirror each other's states. In one embodiment, the mobile home IP address space for the users can be partitioned based on prefix ranges so that each virtual machine handles a group corresponding to a different prefix range. The replicator 330 can maintain a database indicating the mapping between virtual machines and the mobile prefixes that they handle. Both data plane and control plane traffic first reach the replicator 330 and are then forwarded to the corresponding virtual machines based on the mobile home address carried in the messages.

During normal operation, substantially all of the resources available to the blades 305 can be made available to the primary home agents 320. The backup home agents 325 may only consume small amounts of the resources to maintain its mirror state. Since the backup home agents 325 consume very little processing power during normal operations, the primary home agents 320 can use almost all the resources of the host blade 305. The maximum load that can be handled by the home agent server 300 is consequently almost twice as large as in the conventional configuration that uses a single hardware element to host both the primary home agent and the backup home agent. For example, the primary home agents 320 may consume approximately 20-50% of the available resources during normal operation, although this resource consumption may spike to nearly 100% during surges in usage. Thus, handing off the users from a primary 320 to a backup 325 in the event of a primary failure can occur without any substantial decrease in the resource allocation during normal operation.

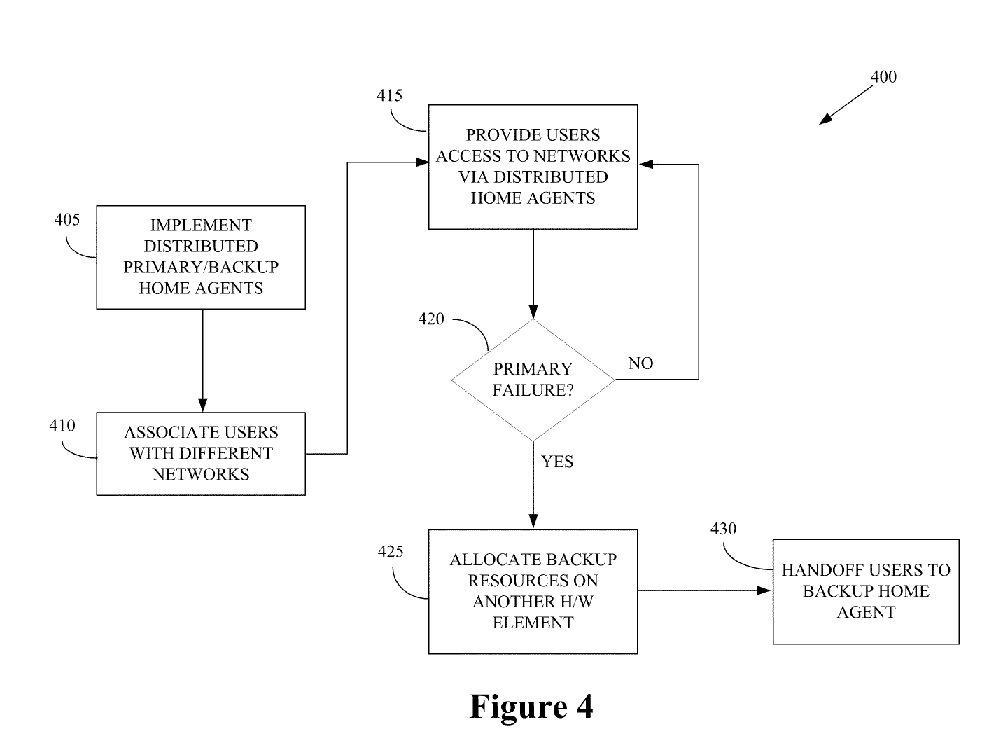

FIG. 4 conceptually illustrates one exemplary embodiment of a method 400 of implementing and operating virtual home agents. In the illustrated embodiment, distributed primary and backup home agents are implemented (at 405) in a wireless communication system. For example, one or more home agent servers may be deployed in the wireless communication system and interconnected with the appropriate networks (such as public and private networks) using well known techniques for deploying servers and networks. Encoded software including algorithms, data structures, and other information used to implement the home agents may be installed on the server. For example, a software representation of the primary home agent may be installed on a first blade of the server and a software representation of the backup home agent may be installed on a second blade of the server. The primary and backup home agents may then be configured so that the backup home agent maintains a mirror of the state of the primary home agent.

Users in the wireless communication system may then be associated (at 410) with different networks and the corresponding home agents. For example, if the wireless communication system provides access to a public network and a private network, users that are registered with and/or are authorized to use the public network may be associated (at 410) with a distributed virtual home agent that includes a primary home agent on a first blade of the server and a backup home agent on a second blade of the server. Users that are registered with and/or are authorized to use the private network may be associated (at 410) with another distributed virtual home agent that includes a primary home agent on the second blade of the server and a backup home agent on the first blade of the server. The server may then provide (at 415) access to the public and private networks via the distributed home agents.

The server may also monitor operation of the primary home agents to determine (at 420) whether any of the primary home agents have failed or otherwise become unavailable. As long as the primary home agents continue to operate normally, the server provides (at 415) access to the public and private networks via the primary home agents. In the event that the server determines (at 420) that one of the primary home agents has failed, backup resources can be allocated (at 425) to the backup home agent associated with the primary home agent. Since the backup home agent maintains a mirror of the state of the primary home agent, the backup home agent is prepared to substantially immediately begin providing access to the users that were being served by the primary home agent at the time the failure was detected. Allocating (at 425) the backup resources may include allocating processing time and/or memory space on the blade that supports the backup home agent, as well as allocating (at 425) bandwidth on the various connections that allow information to be transmitted and/or received by the blade.

Users associated with the failed may then be handed off (at 430) to the associated backup home agent on a different blade. The backup home agent may continue to provide access to these users until the primary home agent again becomes available. For example, the primary home agent may be rebooted, reset, or otherwise reconfigured following the failure so that the primary home agent can resume providing service to the users. The operations used to return the primary home agent to full or partial operation may be performed automatically or they may require intervention by an engineer.

Embodiments of the distributed virtual home agent described herein may provide a number of advantages over the conventional practice. For example, the distributed virtual home agent permits each user group to be handled by a different virtual machine so that information is isolated among groups. Since each virtual machine runs independently, the impact of virtual machine failures can be contained within the corresponding group. Most down time in the current networking equipments is caused by software issues. Consequently, even though virtual machines may share the same hardware, virtualization can isolate the impact of software failures to individual groups. Moreover, resources such as processing time and memory can be allocated separately for each virtual machine so that load can be isolated between user groups. For example, the effects of a sudden increase of activity of users in public group (e.g., a flash crowd) can be confined to the virtual machine that handles the public group so that it does not affect the load on a virtual machine that handles messages of a private group such as an emergency group. Each home agent can run the same or similar software to implement the home agents on the different virtual machines and signaling messages can be distributed to corresponding virtual machines according to the group associated with each user. Generally speaking, the virtual distributed home agent architecture described herein offers the benefit of isolation between groups, which enhances privacy, security, failure containment, and overload control.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
implementing at least one first primary home agent on a first portion of a plurality of hardware elements that operate according to a mobile Internet Protocol (IP) and at least one second primary home agent on a second portion of the plurality of hardware elements;
implementing at least one first backup home agent on the second portion of the plurality of hardware elements and at least one second backup home agent on the first portion of the plurality of hardware elements; and
providing packets addressed to the first or second primary home agent to both the first and second portions of the plurality of hardware elements so that states of the first and second backup home agents mirror states of the first and second primary home agents, respectively.

2. The method of claim 1, comprising associating at least one first mobile unit with the first primary home agent and the first backup home agent and associating at least one second mobile unit with the second primary home agent and the second backup home agent.

3. The method of claim 2, comprising providing said at least one first mobile unit access to a first network via the first primary home agent and the first backup home agent and providing said at least one second mobile unit access to a second network via the second primary home agent and the second backup home agent.

4. The method of claim 3, wherein providing said at least one first mobile unit access to the first network comprises providing said at least one first mobile unit access to a public network.

5. The method of claim 3, wherein providing said at least one second mobile unit access to the second network comprises providing said at least one second mobile unit access to a private network.

6. The method of claim 3, wherein providing said at least one first mobile unit access to the first network comprises preferentially allocating resources of the first portion of the hardware elements to the first primary home agent and wherein providing said at least one second mobile unit access to the second network comprises preferentially allocating resources of the second portion of the hardware elements to the second primary home agent.

7. The method of claim 6, wherein preferentially allocating resources of the first portion of the hardware elements to the first primary home agent comprises making substantially all the resources of the first portion of the hardware elements available to the first primary home agent and wherein preferentially allocating resources of the second portion of the hardware elements to the second primary home agent comprises making substantially all the resources of the second portion of the hardware elements available to the second primary home agent.

8. The method of claim 3, comprising:
detecting failure or unavailability of the first primary home agent; and
providing said at least one first mobile unit access to the first network via the first backup home agent in response to detecting said failure or unavailability of the first primary home agent.

9. The method of claim 8, comprising allocating resources of the second portion of the hardware elements to the first backup home agent so that the first backup home agent can provide said at least one first mobile unit access to the first network.

10. The method of claim 3, comprising:
detecting failure or unavailability of the second primary home agent; and
providing said at least one second mobile unit access to the second network via the second backup home agent in response to detecting said failure or unavailability of the second primary home agent.

11. The method of claim 10, comprising allocating resources of the first portion of the hardware elements to the second backup home agent so that the second backup home agent can provide said at least one second mobile unit access to the second network.

12. An apparatus, comprising:
a plurality of hardware elements, each hardware element comprising processing and memory resources configured to support home agent functionality according to a mobile Internet Protocol (IP), the plurality of hardware elements further comprising:
at least one first primary home agent implemented on a first portion of the plurality of hardware elements and at least one second primary home agent implemented on a second portion of the plurality of hardware elements; and
at least one first backup home agent implemented on the second portion of the plurality of hardware elements and at least one second backup home agent implemented on the first portion of the plurality of hardware elements; and
a replicator configured to provide packets addressed to either the first or second primary home agent to both the first and second portions of the plurality of hardware elements so that states of the first and second backup home agents mirror states of the first and second primary home agents, respectively.

13. The apparatus of claim 12, wherein the plurality of hardware elements comprises a plurality of blades mounted on a chassis.

14. The apparatus of claim 12, wherein the replicator is implemented in at least one line card.

15. The apparatus of claim 12, wherein said at least one first primary home agent and said at least one first backup home agent are configured to provide access to at least one first mobile unit, and wherein said at least one second primary home agent and said at least one second backup home agent are configured to provide access to at least one second mobile unit.

16. The apparatus of claim 15, wherein said at least one first primary home agent and said at least one first backup home agent are configured to provide said at least one first mobile unit access to a public network.

17. The apparatus of claim 15, wherein said at least one second primary home agent and said at least one second backup home agent are configured to provide said at least one second mobile unit access to a private network.

18. The apparatus of claim 15, wherein the first portion of the hardware elements are configured to preferentially allocate resources to the first primary home agent and wherein the second portion of the hardware elements are configured to preferentially allocate resources to the second primary home agent.

19. The apparatus of claim 18, wherein the first portion of the hardware elements are configured to make substantially all their resources available to the first primary home agent and wherein the second portion of the hardware elements are configured to make substantially all their resources available to the second primary home agent.

20. The apparatus of claim 18, wherein the first backup home agent is configured to provide access to said at least one first mobile unit in response to failure or unavailability of the first primary home agent, and wherein the second portion of the hardware elements are configured to allocate resources to the first backup home agent so that the first backup home agent can provide said at least one first mobile unit access to the first network.

21. The apparatus of claim 18, wherein the second backup home agent is configured to provide access to said at least one second mobile unit in response to failure or unavailability of the second primary home agent, and wherein the first portion of the hardware elements are configured to allocate resources to the second backup home agent so that the second backup home agent can provide said at least one second mobile unit access to the second network.
